(19) United States
(12) Patent Application Publication
(10) Pub. No.: US 2014/0214375 A1
(43) Pub. Date: Jul. 31, 2014

(54) ARITHMETIC APPARATUS AND ARITHMETIC METHOD

(71) Applicant: FUJITSU LIMITED, Kawasaki-shi (JP)

(72) Inventor: Masaaki KAWAHITO, Fuchu (JP)

(73) Assignee: FUJITSU LIMITED, Kawasaki-shi (JP)

(21) Appl. No.: 14/065,797

(22) Filed: Oct. 29, 2013

(30) Foreign Application Priority Data
Jan. 31, 2013 (JP) 2013-017940

(51) Int. Cl. G06F 17/50

(52) U.S. Cl. CPC G06F 17/5009
USPC 703/2

(57) ABSTRACT

An arithmetic method executed by a computer, the arithmetic method includes performing arithmetic operation to simulate conveyance of an object by a conveying device in a three-dimensional simulation space in which the object and the conveying device are disposed, the conveying device moving the object by pushing the object with a pushing-out surface of a pusher or lifting up the object by supporting the object from below with a supporting surface of a lifter, and moving the object to a position where the object is in contact with the pushing-out surface of the pusher or the supporting surface of the lifter when it is detected that a certain reference point of the object is present in a certain region in a moving direction of the pushing-out surface of the pusher or the supporting surface of the lifter in the arithmetic operation to simulate the conveyance.

### CROSS-REFERENCE TO RELATED APPLICATION(S)

This application is based upon and claims the benefit of priority of the prior Japanese Patent Application No. 2013-017940, filed on Jan. 31, 2013, the entire contents of which are incorporated herein by reference.

### FIELD

The embodiments discussed herein are directed to an arithmetic apparatus and an arithmetic method.

### BACKGROUND

Techniques have been known that simulate conveying conditions of conveyed objects called workpieces. A technique has been known, for example, that verifies whether a workpiece is appropriately conveyed by operating a conveying device in a simulation space in accordance with a control program so as to debug the control program controlling the conveying device such as a belt conveyer, a suction chuck, a pusher, or a lifter.

One way to realize the conveyance of the workpiece in the simulation space is to detect interference of the conveying device with the workpiece and simulate conveyance of the workpiece in accordance with a movement of the conveying device interfering with the workpiece. When determining whether the respective conveying devices interfere with the workpieces for all elements, while the movements of a number of workpieces and a plurality of conveying devices are simulated simultaneously, the calculation amount becomes huge.

Techniques have been known that simplify the calculation in this simulation. An example of such techniques performs the calculation in the simulation on the basis of an assumption that the conveying device and the workpiece are integrated when the conveying device and the workpiece approach within a predetermined distance.

With regard to the conventional technologies, refer to Japanese Laid-open Patent Publication No. 11-33955 and Japanese Laid-open Patent Publication No. 2002-68416, for example.

In the technique performing the calculation in the simulation on the basis of the assumption that the conveying device and the workpiece are integrated, there is a case where the workpiece is not conveyed in a posture actually conveyed by the conveying device or a case where the workpiece is conveyed while being embedded in the conveying device. In such a case, the workpiece is conveyed in a condition different from the actual condition. As a result, a positional shift of the workpiece occurs in some cases. Thus, the technique performing the calculation in the simulation on the basis of the assumption that the conveying device and the workpiece are integrated has a problem in that accuracy of the simulation is not high.

### SUMMARY

According to an aspect of an embodiment, a computer-readable recording medium having stored therein a computer program that causes a computer to execute a process including: performing arithmetic operation to simulate conveyance of an object by a conveying device in a three-dimensional simulation space in which the object and the conveying device are disposed, the conveying device moving the object by pushing the object with a pushing-out surface of a pusher or lifting up the object by supporting the object from below with a supporting surface of a lifter; and moving the object to a position where the object is in contact with the pushing-out surface of the pusher or the supporting surface of the lifter when it is detected that a certain reference point of the object is present in a certain region in a moving direction of the pushing-out surface of the pusher or the supporting surface of the lifter at the performing the arithmetic operation to simulate the conveyance.

According to another aspect of an embodiment, an arithmetic apparatus includes an executing unit and a movement controller. The executing unit performs arithmetic operation to simulate conveyance of an object by a conveying device in a three-dimensional simulation space in which the object and the conveying device are disposed, the conveying device moving the object by pushing the object with a pushing-out surface of a pusher or lifting up the object by supporting the object from below with a supporting surface of a lifter. The movement controller moves the object to a position where the object is in contact with the pushing-out surface of the pusher or the supporting surface of the lifter when it is detected that a certain reference point of the object is present in a certain region in a moving direction of the pushing-out surface of the pusher or the supporting surface of the lifter in the arithmetic operation to simulate the conveyance.

According to still another aspect of an embodiment, an arithmetic method executed by a computer, the arithmetic method includes: performing arithmetic operation to simulate conveyance of an object by a conveying device in a three-dimensional simulation space in which the object and the conveying device are disposed, the conveying device moving the object by pushing the object with a pushing-out surface of a pusher or lifting up the object by supporting the object from below with a supporting surface of a lifter; and moving the object to a position where the object is in contact with the pushing-out surface of the pusher or the supporting surface of the lifter when it is detected that a certain reference point of the object is present in a certain region in a moving direction of the pushing-out surface of the pusher or the supporting surface of the lifter in the arithmetic operation to simulate the conveyance.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a functional structure of an arithmetic apparatus according to an embodiment;

FIG. 2A is a schematic diagram for explaining an example of processing performed by the arithmetic apparatus to determine a contact between a conveying device and a workpiece;

FIG. 2B is a schematic diagram for explaining another example of the processing performed by the arithmetic apparatus to determine the contact between the conveying device and the workpiece;

FIG. 3 is a schematic diagram illustrating an example of a conveying part shape table;

FIG. 4 is a schematic diagram illustrating an example of a conveying motion information table;

FIG. 5 is a schematic diagram illustrating an example of a workpiece shape table;

FIG. 6 is a schematic diagram illustrating an example of a workpiece posture table;

FIG. 7 is a schematic diagram illustrating an example of a contact determining cuboid table;

FIG. 8 is a schematic diagram illustrating an example of a contact plane table;

FIG. 9 is a schematic diagram for explaining a contact determining cuboid of the workpiece;

FIG. 10A is a schematic diagram for explaining a conveyance feasible region of a pusher;

FIG. 10B is a schematic diagram for explaining the conveyance feasible region of a lifter;

FIG. 11 is a schematic diagram for explaining an example of processing performed by a workpiece movement arithmetic unit;

FIG. 12 is a schematic diagram for explaining another example of the processing performed by the workpiece movement arithmetic unit;

FIG. 13 is a flowchart for explaining a flow of processing to determine the contact of the workpiece and the conveying device at a certain time step;

FIG. 14 is a flowchart for explaining a flow of processing to calculate the position of the workpiece at a certain time step;

FIG. 15 is a flowchart for explaining a flow of processing to calculate the position of the workpiece when the workpiece and the lifter are in a contacting state at a certain time step;

FIG. 16 is a flowchart for explaining processing to cancel the contacting state between the pusher and the workpiece at a certain time step;

FIG. 17 is a flowchart for explaining processing to cancel the contacting state between the lifter and the workpiece at a certain time step; and

FIG. 18 is a schematic diagram for explaining an example of a computer executing a simulation program.

### DESCRIPTION OF EMBODIMENTS

Preferred embodiments of the present invention will be explained with reference to accompanying drawings.

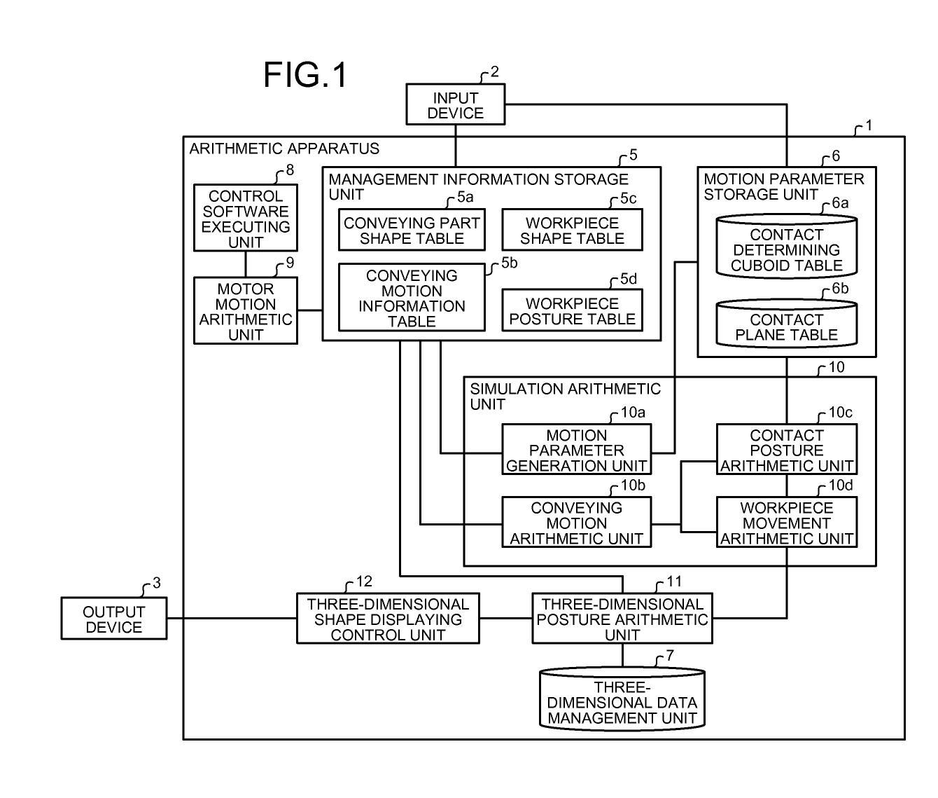

In the embodiments, an arithmetic apparatus is described that simulates a conveyance of a workpiece. FIG. 1 is a schematic diagram illustrating an example of a functional structure of the arithmetic apparatus according to an embodiment. As illustrated in FIG. 1, an arithmetic apparatus 1 is coupled to an input device 2 and an output device 3. The arithmetic apparatus 1 includes a management information storage unit 5, a motion parameter storage unit 6, and a three-dimensional data management unit 7. The arithmetic apparatus 1 also includes a control software executing unit 8, a motor motion arithmetic unit 9, a simulation arithmetic unit 10, a three-dimensional posture arithmetic unit 11, and a three-dimensional shape displaying control unit 12.

The management information storage unit 5 includes a conveying part shape table 5a, a conveying motion information table 5b, a workpiece shape table 5c, and a workpiece posture table 5d. The motion parameter storage unit 6 includes a contact determining cuboid table 6a, and a contact plane table 6b. The simulation arithmetic unit 10 includes a motion parameter generation unit 10a, a conveying motion arithmetic unit 10b, a contact posture arithmetic unit 10c, and a workpiece movement arithmetic unit 10d.

The arithmetic apparatus 1 simulates the conveying conditions of the workpiece at respective time steps T₁, T₂, . . . , T_{N}, and causes the output device 3 to output the simulated results. The results make it possible for a developer of control software controlling a conveying device to verify whether the control software appropriately controls the conveying device. The arithmetic apparatus 1 acquires, from the input device 2, information about the shape of the workpiece the conveyance of which is simulated in the simulation space, the posture of the workpiece at an initial stage (time step T1), and functions and an initial disposition of the conveying device conveying the workpiece, for example. The arithmetic apparatus 1 acquires three-dimensional model data produced by a computer aided design (CAD) of the workpiece and postural data of the workpiece at the initial stage, for example. The arithmetic apparatus 1 also acquires the three-dimensional model data of the conveying device such as a pusher, a belt conveyer, a suction chuck, or a lifter, produced by the CAD, and the disposed location of the conveying device at the initial stage, for example. The arithmetic apparatus 1 performs conveyance simulation of the workpiece from the time step T₁ to the time step T_{N} using the acquired three-dimensional model data and causes the output device 3, such as a monitor or a printer, to output the results. The arithmetic apparatus 1 causes the output device 3 to output and display video images in which the workpieces are conveyed by the various conveying devices, for example.

When the workpiece and the conveying device conveying the workpiece are in contact with each other, the arithmetic apparatus 1 extracts a moving amount of a component in a direction in which the posture of the conveying device changes out of the components in a moving direction of the conveying device, and moves the workpiece by the extracted moving amount. This makes it possible to individually simulate the workpiece and the conveying device. When the conveying device conveys the workpiece while sliding on a surface of the workpiece and the workpiece and the conveying device which are in contact with each other are integrated, the conveying device would not slide on the surface of the workpiece. Thus, the simulation performed on the basis of the assumption that the workpiece and the conveying device which are in contact with each other are integrated does not simulate the conveying condition of the workpiece with high accuracy in some cases. In contrast, the arithmetic apparatus 1 extracts the moving amount of the component in the direction in which the posture of the conveying device changes out of the components in the moving direction of the conveying device, and moves the workpiece by the extracted moving amount. As a result, the arithmetic apparatus 1 can perform the simulation with high accuracy even when the conveying device conveys the workpiece while sliding on a surface of the working piece.

The timing when it is determined that the conveying device and the workpiece are in contact with each other may be the timing when the conveying device and the workpiece interfere with each other and the length of the interfering portion is within a predetermined threshold as a result of the check of the interference between the conveying device and the workpiece, for example. If such timing is used as the timing when the conveying device and the workpiece are in contact with each other, the conveying condition of the workpiece is simulated while the conveying device is embedded in the workpiece. That is, the conveying condition of the workpiece is simulated in a state different from an actual state where the conveying device conveys the workpiece. Thus, the use of such timing as the timing when the conveying device and the workpiece are in contact with each other causes positional accuracy of the workpiece calculated in the simulation to deteriorate. Consequently, using such timing as the timing when the conveying device and the workpiece are in contact with each other will prevent accurate verification of the control program.

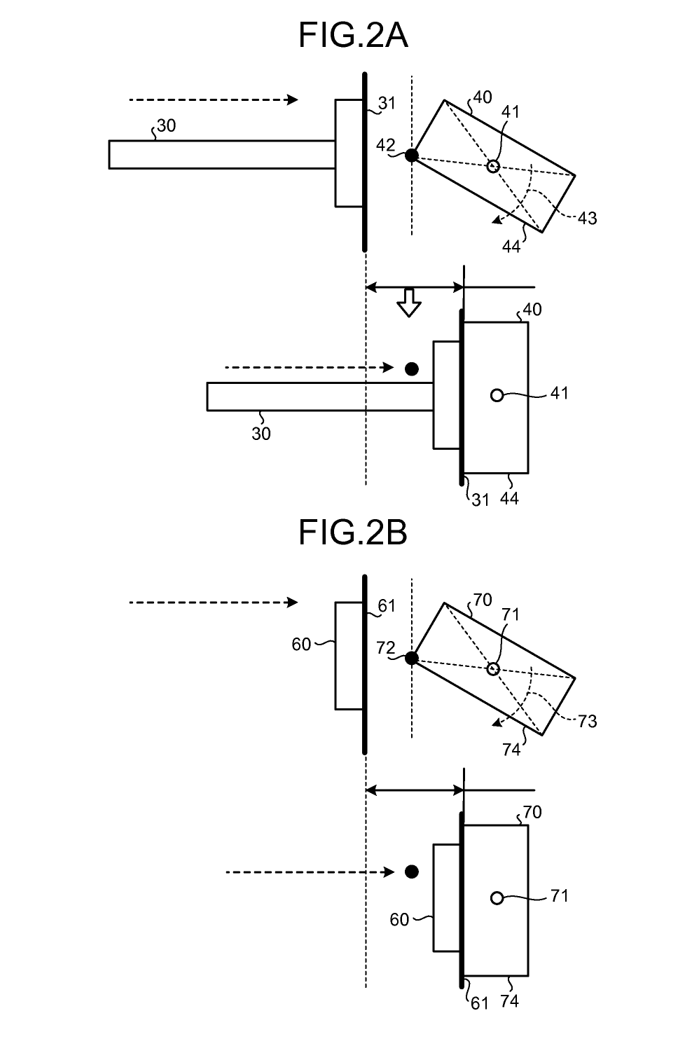

The arithmetic apparatus 1 performs the following processing. FIG. 2A is a schematic diagram for explaining an example of processing performed by the arithmetic apparatus to determine a contact between the conveying device and the workpiece. The arithmetic apparatus 1 performs the following processing when a pusher 30 moves and, as a result of the movement, a gravity center 41 of a contact determining cuboid of a workpiece 40 is included in a conveyance feasible region set to the pusher 30 at a certain time step as illustrated in the example of FIG. 2A, for example. The arithmetic apparatus 1 calculates a rotational amount of the contact determining cuboid when a surface of the workpiece 40 and a contact surface 31 set to the contact determining cuboid of the pusher 30 as a surface pushing out the workpiece 40 are in parallel with each other, and determines a rotational direction of the contact determining cuboid. The arithmetic apparatus 1 sets, for each conveying device, a certain conveyance feasible region from a contact plane serving as the pushing-out surface by which the conveying device pushes the workpiece toward a pushing-out direction of the workpiece. The arithmetic apparatus 1 determines a direction 43 as the rotational direction of the contact determining cuboid of the workpiece 40, for example. In the direction 43, the contact determining cuboid of the workpiece 40 is rotated about the gravity center 41 when the pusher 30 pushes a point 42, which is the nearest point to the contact surface 31, of the contact determining cuboid of the workpiece 40 in the moving direction of the pusher 30. The arithmetic apparatus 1 also calculates the rotational amount of the contact determining cuboid when the contact surface 31 and a surface of the workpiece 40 are in parallel with each other as a result of the rotation. When the pusher 30 moves to a position where the pusher 30 is in contact with a surface 44 of the contact determining cuboid, the arithmetic apparatus 1 rotates the contact determining cuboid of the workpiece 40 by the calculated rotational amount in the determined rotational direction. The arithmetic apparatus 1 then determines that the pusher 30 and the workpiece 40 are in contact with each other. This makes it possible for the arithmetic apparatus 1 to simulate the conveying condition of the workpiece 40 in the same state as the pusher actually conveys the workpiece without the state where the pusher 30 is embedded in the workpiece 40. The arithmetic apparatus 1 thus can suppress a deterioration in positional accuracy of the workpiece calculated in the simulation. Consequently, the arithmetic apparatus 1 enables the control program to be verified with high accuracy.

In the arithmetic apparatus 1, the posture of the workpiece 40 when conveyed by the pusher 30 is the same as that when actually conveyed by the pusher. This makes it possible for the arithmetic apparatus 1 to simulate the conveying condition of the workpiece 40 in the same state as the pusher actually conveys the workpiece. The arithmetic apparatus 1 thus can suppress a deterioration in positional accuracy of the workpiece calculated in the simulation. Consequently, the arithmetic apparatus 1 enables the control program to be verified with high accuracy.

FIG. 2B is a schematic diagram for explaining another example of the processing performed by the arithmetic apparatus to determine the contact between the conveying device and the workpiece. The arithmetic apparatus 1 performs the following processing when a lifter 60 moves and, as a result of the movement, a gravity center 71 of the contact determining cuboid of a workpiece 70 is included in the conveyance feasible region set to the lifter 60 at a certain time step as illustrated in the example of FIG. 2B, for example. The arithmetic apparatus 1 calculates the rotational amount of the contact determining cuboid when a surface of the workpiece 70 and a contact surface 61 set to the contact determining cuboid of the lifter 60 as a surface pushing out the workpiece 70 are in parallel with each other, and determines a rotational direction of the contact determining cuboid. The arithmetic apparatus 1 sets, for each conveying device, a certain conveyance feasible region from a contact plane serving as a lifting up surface by which the conveying device lifts up the workpiece toward a lifting up direction of the workpiece. The arithmetic apparatus 1 determines a direction 73 as the rotational direction of the contact determining cuboid of the workpiece 70, for example. In the direction 73, the contact determining cuboid of the workpiece 70 is rotated about the gravity center 71 when the lifter 60 pushes a point 72, which is the nearest point to the contact surface 61, of the contact determining cuboid of the workpiece 70 in the moving direction of the lifter 60. The arithmetic apparatus 1 also calculates the rotational amount of the contact determining cuboid when the contact surface 61 and the surface of the workpiece 70 are in parallel with each other as a result of the rotation. When the lifter 60 moves to a position where the lifter 60 is in contact with a surface 74 of the contact determining cuboid, the arithmetic apparatus 1 rotates the contact determining cuboid of the workpiece 70 by the calculated rotational amount in the determined rotational direction. The arithmetic apparatus 1 then determines that the lifter 60 and the workpiece 70 are in contact with each other. This makes it possible for the arithmetic apparatus 1 to simulate the conveying condition of the workpiece 70 in the same state as the lifter actually conveys the workpiece without the state where the lifter 60 is embedded in the workpiece 70. The arithmetic apparatus 1 thus can suppress a deterioration in positional accuracy of the workpiece calculated in the simulation. Consequently, the arithmetic apparatus 1 enables the control program to be verified with high accuracy.

In the arithmetic apparatus 1, the posture of the workpiece 70 when conveyed by the lifter 60 is the same as that when actually conveyed by the lifter. This makes it possible for the arithmetic apparatus 1 to simulate the conveying condition of the workpiece 70 in the same state as the lifter actually conveys the workpiece. The arithmetic apparatus 1 thus can suppress a deterioration in positional accuracy of the workpiece calculated in the simulation. Consequently, the arithmetic apparatus 1 enables the control program to be verified with high accuracy.

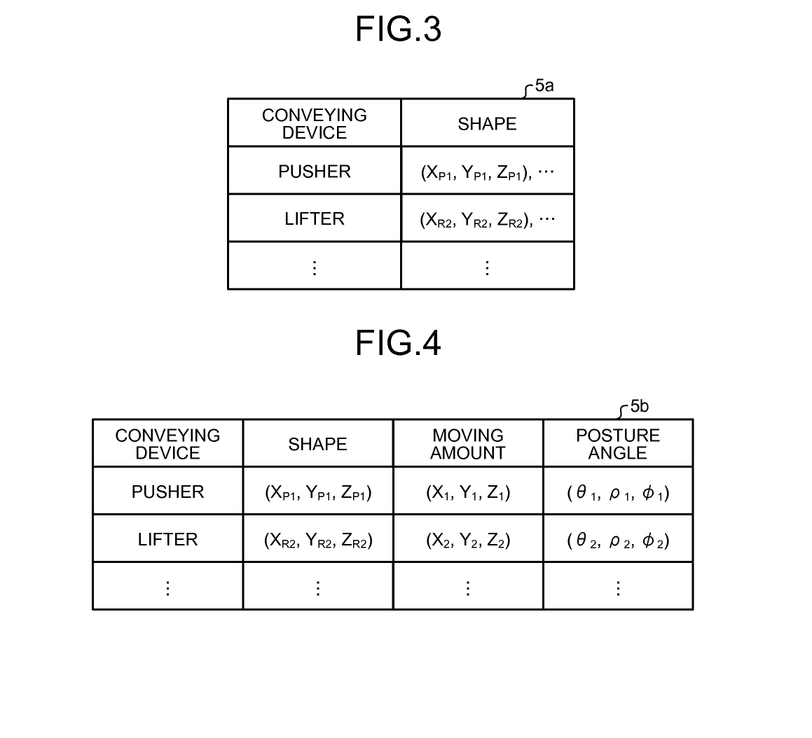

The following describes examples of the respective functions illustrated in FIG. 1. The conveying part shape table 5a stores therein data indicating the shapes of the conveying devices, such as the pusher and the lifter, input from the input device 2. FIG. 3 is a schematic diagram illustrating an example of the conveying part shape table. The example illustrated in FIG. 3 is a case where vertex coordinates of triangle planes (polygons) constituting the surfaces of the pusher and the lifter are stored in the conveying part shape table 5a as the shapes of the pusher and the lifter arranged in the simulation space.

The example of FIG. 3 illustrates a case where the conveying part shape table 5a stores therein the respective vertex coordinates “(X_{P1}, Y_{P1}, Z_{P1}), . . . ” of a plurality of polygons constituting a surface of a certain pusher. In the example of FIG. 3, the simplest polygon data is stored. The data is not limited to the example. Polygon data including data of the sides of the polygons may be stored in the conveying part shape table 5a, for example. The conveying part shape table 5a may store therein lines constituting free-form surfaces and dots constituting the lines in a hierarchical manner. That is, the conveying part shape table 5a stores therein data expressing the conveying devices in the simulation space in any format.

The conveying motion information table 5b stores therein data indicating the motions of the conveying devices. FIG. 4 is a schematic diagram illustrating an example of the conveying motion information table. In the example illustrated in FIG. 4, the conveying motion information table stores therein the gravity center positions, movement vectors indicating the moving amounts and the moving directions, and posture angles of the respective conveying devices at the latest time step Tₖ (k=1, . . . , N) in the simulation performed by the arithmetic apparatus 1 in association with each other.

The example illustrated in FIG. 4 is a case where the conveying motion information table 5b stores therein the gravity center position, “(X_{P1}, Y_{P1}, Z_{P1})”, the moving amount and the moving direction, “(X₁, Y₁, Z₁)”, and the posture angle, “(θ₁, ρ₁, φ₁)”, of a certain pusher at a certain time step. θ, ρ, and φ are information about angles indicating the respective degrees of the rotations about the respective axes (X axis, Y axis, and Z axis) in the three-dimensional space. The gravity center position and the posture angle of the conveying device stored in the conveying motion information table 5b at the time step Tₖ are updated to values newly calculated by the three-dimensional posture arithmetic unit 11, which is described later, at the time step Tₖ. The movement vector stored in the conveying motion information table 5b at the time step Tₖ is updated to a value newly calculated by the motor motion arithmetic unit 9 at the time step Tₖ. In a period from when the movement vector is registered by the motor motion arithmetic unit 9 at the time step Tₖ to when the gravity center position and the posture angle of the conveying device are registered by the three-dimensional posture arithmetic unit 11, the registered contents in the conveying motion information table 5b are as follows. In the conveying motion information table 5b, the movement vector at the time step Tₖ and the position and the posture angle of the conveying device at the time step Tₖ₋ₗ are registered in association with each other. The followings are the registered contents in the conveying motion information table 5b referred to by the motion parameter generation unit 10a, the conveying motion arithmetic unit 10b, the contact posture arithmetic unit 10c, and the workpiece movement arithmetic unit 10d, which are described later, at the time step Tₖ. The registered contents are the movement vector at the time step Tₖ and the position and the posture angle of the conveying device at the time step Tₖ₋₁.

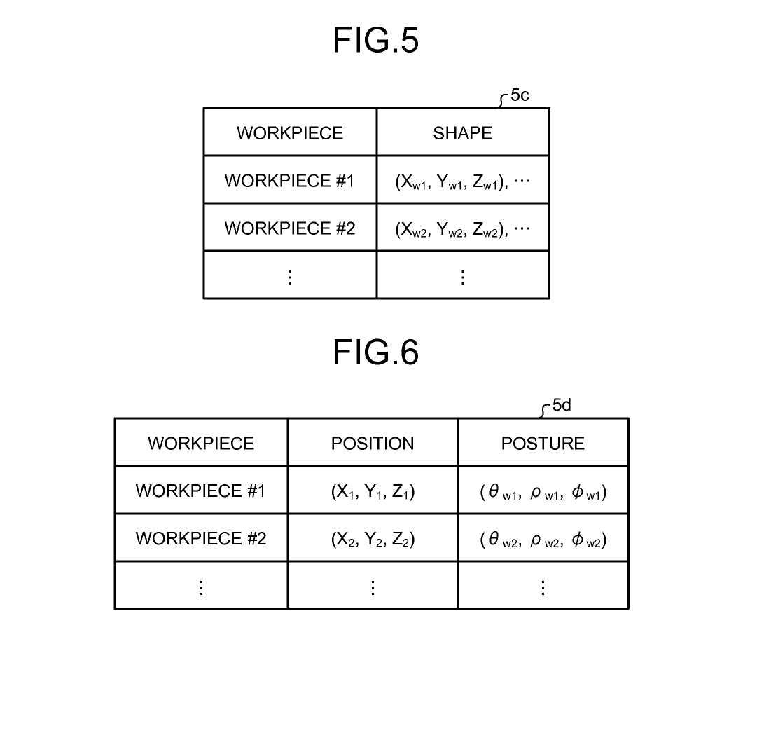

Referring back to FIG. 1, the workpiece shape table 5c stores therein the shapes of the workpieces conveyed by the respective conveying devices in the simulation space. FIG. 5 is a schematic diagram illustrating an example of the workpiece shape table. The example of FIG. 5 illustrates a case where the workpiece shape table 5c stores therein the vertex coordinates of the triangle planes (polygons) constituting a surface of work #1. The example of FIG. 5 illustrates the case where the workpiece shape table 5c stores therein the coordinate data, “(X_{W1}, Y_{W1}, Z_{W1}), . . . ”, of the polygons constituting the surface of work #1. The workpiece shape table 5c may store therein the data of free-form surfaces in the same manner as the conveying part shape table 5a.

The workpiece posture table 5d stores therein data indicating the postures of the respective workpieces. FIG. 6 is a schematic diagram illustrating an example of the workpiece posture table. In the example illustrated in FIG. 6, the workpiece posture table 5d stores therein the gravity center positions of the contact determining cuboids of the respective workpieces, and data of the postures indicating the degrees of the rotations of the respective contact determining cuboids about the respective axes origins of which are the gravity centers of the respective contact determining cuboids.

The example of FIG. 6 illustrates a case where the workpiece posture table 5d stores therein the gravity center position, “(X₁, Y₁, Z₁)”, and the posture angle, “(θ_{W1}, ρ_{W1}, φ_{W1}”, of the contact determining cuboid of workpiece #1. The gravity center positions and the postures stored in the workpiece posture table 5d are updated, at the time step T₁, to the gravity center positions and the postures newly calculated by the three-dimensional posture arithmetic unit 11 at the time step Tₖ. In a period until the gravity center positions and the posture angles of the contact determining cuboids of the respective workpieces are registered by the three-dimensional posture arithmetic unit 11 at the time step Tₖ, the registered contents in the workpiece posture table 5d are as follows. In the workpiece posture table 5d, the gravity center positions and the posture angles of the respective workpieces at the time step Tₖ₋₁ are registered in the workpiece posture table 5d in association with each other. The followings are the registered contents in the workpiece posture table 5d referred to by the motion parameter generation unit 10a, the conveying motion arithmetic unit 10b, the contact posture arithmetic unit 10c, and the workpiece movement arithmetic unit 10d, which are described later, at the time step Tₖ. The registered contents are the gravity center positions and the posture angles of the contact determining cuboids of the respective workpieces at the time step Tₖ₋₁.

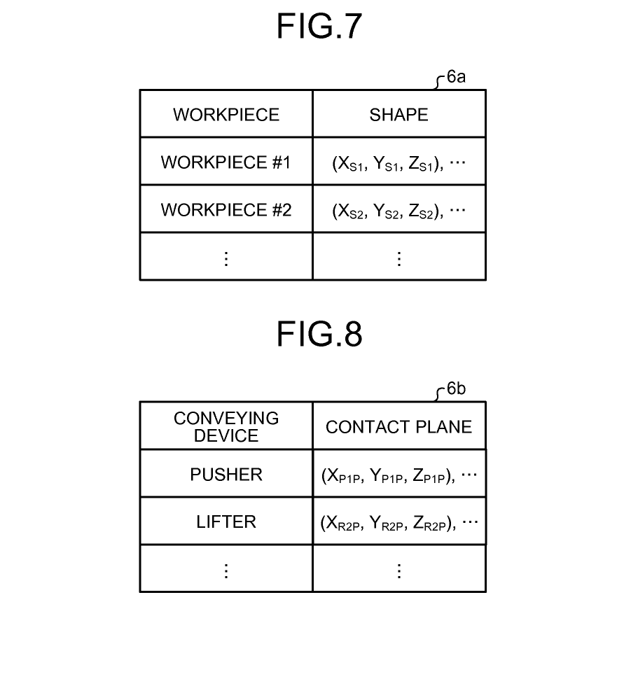

Referring back to FIG. 1, the contact determining cuboid table 6a stores therein the data of the polygons constituting the surfaces of the contact determining cuboids, which are cuboids and surround the respective workpieces in a circumscribing manner. The respective contact determining cuboids are produced by the three-dimensional shape displaying control unit 12, which is described later, at the time step Tₖ on the basis of the gravity center positions and the shapes of the respective workpieces at the time step Tₖ₋₁, which is the time step just before the time step Tₖ. FIG. 7 is a schematic diagram illustrating an example of the contact determining cuboid table. The example of FIG. 7 illustrates a case where the contact determining cuboid table 6a stores therein the data of the polygons, “(X_{S1}, Y_{S1}, Z_{S1}), . . . ”, constituting the surface of the contact determining cuboid produced at the time step Tₖ on the basis of the gravity center position and the posture of workpiece #1 at the time step Tₖ₋₁.

The contact plane table 6b stores therein the vertex coordinates of the contact plane, which is the plane in contact with the workpiece during the conveyance of the workpiece, for each type of conveying devices. FIG. 8 is a schematic diagram illustrating an example of the contact plane table. The example of FIG. 8 illustrates a case where the contact plane table 6b stores therein the vertex coordinates, “(X_{P1P}, Y_{P1P}, Z_{P1P}), . . . ”, of the contact plane of a certain pusher. Information indicating that which side of both sides of the contact plane of the conveying device is in contact with the workpiece is registered in the contact plane table 6b. The information is omitted to be illustrated in FIG. 8. The vertex coordinates of the contact plane at the respective time steps are produced by the motion parameter generation unit 10a, which is described later. The motion parameter generation unit 10a registers the vertex coordinates of the contact plane at the respective time steps in the contact plane table 6b to update the contact plane table 6b.

Referring back to FIG. 1, the three-dimensional data management unit 7 stores therein various types of data used for producing a simulation image. The three-dimensional data management unit 7 stores therein the polygon data of the workpieces and the conveying devices and information designating colors used for displaying the simulation image, for example.

The control software executing unit 8 executes the control software serving as a debugging target. The control software executing unit 8 executes control software that produces control signals of servo motors causing respective conveying devices to move in a factory serving as the simulation target, for example. The control software executing unit 8 outputs the contents of the control signals produced by the control software to the motor motion arithmetic unit 9 sequentially from the time step T₁ to the time step T_{N} for each time step. The control software executing unit 8 notifies the motor motion arithmetic unit 9 of the on timing of pulse signals indicating on and off of the servo motors, time periods of the on states, and plus and minus polarities of the pulses, for example.

The motor motion arithmetic unit 9 calculates the rotational speeds of the servo motors causing the respective conveying devices to move for each time step in accordance with the contents of the control signals received from the control software executing unit 8, for example. The motor motion arithmetic unit 9 produces the movement vectors indicating the moving amounts and the moving directions of the respective conveying devices for each time step using the calculation results, and stores the produced movement vectors in the conveying motion information table 5b. When receiving the content of the control signal for the servo motor causing the pusher to move at a certain time step, for example, the motor motion arithmetic unit 9 calculates the rotational direction and the rotational speed of the servo motor in accordance with the received control signal. The motor motion arithmetic unit 9 then calculates the movement vector indicating the moving amount and the moving direction of the pusher on the basis of the calculated rotational direction and the rotational speed of the servo motor, and stores the calculated movement vector in the conveying motion information table 5b to update the conveying motion information table 5b. The motor motion arithmetic unit 9 also calculates the rotational amounts of the shafts of the respective conveying devices and stores the calculation results in an item (not illustrated) in the conveying motion information table 5b.

The motion parameter generation unit 10a produces the motion parameters for each time step using various types of information stored in the management information storage unit 5 and stores the produced motion parameters in the motion parameter storage unit 6.

The motion parameters are pieces of information used for the arithmetic apparatus 1 to simulate the conveying conditions of the workpieces. The motion parameters are the pieces of information used for a contact determination determining whether the respective conveying devices are in contact with the corresponding workpieces. They are the positional information about the contact determining cuboid surrounding the workpiece in a circumscribing manner and the positional information about the contact plane in contact with the workpiece when the conveying device conveys the workpiece.

The following describes the operation of the motion parameter generation unit 10a. The motion parameter generation unit 10a acquires, at the time step Tₖ, the shapes of the respective workpieces and the gravity center positions and the postures of the contact determining cuboids of the respective workpieces at the time step Tₖ₋₁ from the workpiece shape table 5c and the workpiece posture table 5d. Subsequently, the motion parameter generation unit 10a produces the data of polygons constituting the surfaces of the respective contact determining cuboids surrounding the corresponding workpieces in a circumscribing manner on the basis of the acquired shapes of the respective workpieces, gravity center positions, and postures, and stores the produced polygon data in the contact determining cuboid table 6a.

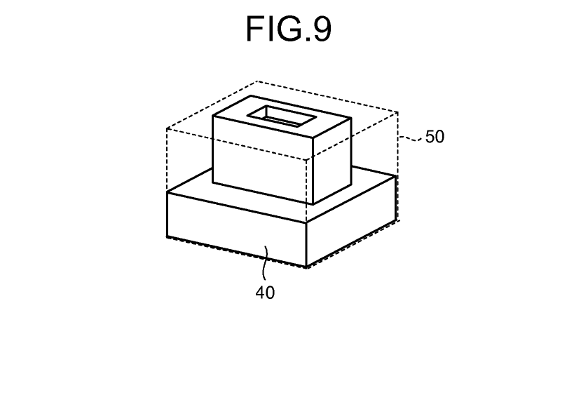

FIG. 9 is a schematic diagram for explaining the contact determining cuboid of the workpiece. The motion parameter generation unit 10a identifies a cuboid 50 indicated with the dotted line in FIG. 9 as the contact determining cuboid of the workpiece 40 indicated with the solid line, for example. That is, the motion parameter generation unit 10a identifies the cuboid 50 surrounding the workpiece 40 in a circumscribing manner. Thereafter, the motion parameter generation unit 10a produces the data of the polygons constituting the surface of the identified cuboid 50 and stores the produced polygon data in the contact determining cuboid table 6a. The motion parameter generation unit 10a performs the processing to produce the polygon data on the respective workpieces for each time step.

The motion parameter generation unit 10a receives and acquires, at the time step Tₖ, the gravity center positions and the postures of the respective conveying devices at the time step Tₖ transmitted from the conveying motion arithmetic unit 10b. The motion parameter generation unit 10a acquires the polygon data indicating the shapes of the respective conveying devices from the conveying part shape table 5a. The motion parameter generation unit 10a produces the following data using the acquired shapes of the respective conveying devices, and the acquired gravity centers and postures of the respective conveying devices at the time step Tₖ. The motion parameter generation unit 10a produces the vertex coordinates of the contact plane, which is the surface pushing out or lifting up the contacted workpiece when the conveying device is in contact with the workpiece, and stores the produced vertex coordinates of the contact plane in the contact plane table 6b. The motion parameter generation unit 10a can set a surface of the conveying device as the contact plane, the surface having the normal vector in the direction in which the conveying device pushes out or lifts up the workpiece. The motion parameter generation unit 10a produces the vertex coordinates of the contact surface 31 of the pusher 30, which is illustrated in the example of FIG. 2A, and stores the produced vertex coordinates in the contact plane table 6b, for example. The motion parameter generation unit 10a performs the processing, for each time step, to produce the contact plane on the respective conveying devices.

The conveying motion arithmetic unit 10b calculates the gravity center positions of the respective conveying devices in the simulation space at the time step Tₖ. The conveying motion arithmetic unit 10b acquires, at the time step Tₖ, the gravity center positions at the time step Tₖ₋₁ and the movement vectors at the time step Tₖ of the respective conveying devices, which are stored in the conveying motion information table 5b, for example.

The conveying motion arithmetic unit 10b calculates the gravity center positions of the respective conveying devices at the time step Tₖ on the basis of the gravity center positions at the time step Tₖ₋₁ and the movement vectors at the time step Tₖ of the respective conveying devices. The conveying motion arithmetic unit 10b then outputs the gravity center positions of the respective conveying devices and the movement vectors of the respective conveying devices at the time step Tₖ to the motion parameter generation unit 10a, the contact posture arithmetic unit 10c, and the workpiece movement arithmetic unit 10d.

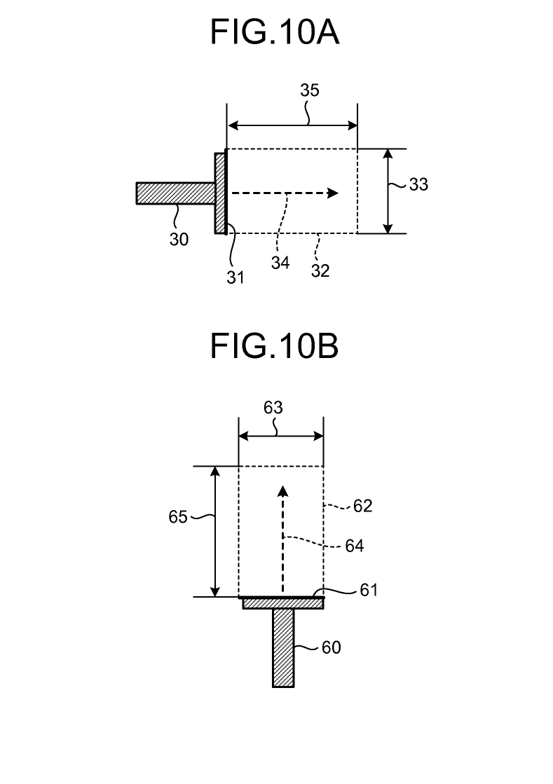

The contact posture arithmetic unit 10c determines the contact of the workpiece using the information stored in the motion parameter storage unit 6 and the gravity center positions of the respective conveying devices output from the conveying motion arithmetic unit 10b. The contact posture arithmetic unit 10c acquires the shapes of the contact determining cuboids and the shapes of the contact planes of the respective conveying devices from the contact determining cuboid table 6a and the contact plane table 6b, for example. The contact posture arithmetic unit 10c sets the conveyance feasible regions, which are used for determining whether the conveyance of the workpieces starts, on the contact planes of the respective conveying devices. The contact posture arithmetic unit 10c sets certain conveyance feasible regions on the contact planes in the moving directions of the respective conveying devices, for example. FIG. 10A is a schematic diagram for explaining the conveyance feasible region of the pusher. As illustrated in the example of FIG. 10A, the contact posture arithmetic unit 10c produces the polygon data of a conveyance feasible region 32, which are used for determining whether the conveyance of the workpiece starts and which are set on the contact surface 31 (contact plane) of the pusher 30, for example. As illustrated in the example of FIG. 10A, the conveyance feasible region 32 has a width 33 the same as the width of the contact surface 31 of the pusher 30 and a length 35 the same as the length of the contact determining cuboid of the workpiece conveyed by the pusher 30 in a moving direction 34 of the pusher 30. The contact posture arithmetic unit 10c sets the produced conveyance feasible region 32 on the contact surface 31 of the pusher 30.

FIG. 10B is a schematic diagram for explaining the conveyance feasible region of the lifter. As illustrated in the example of FIG. 10B, the contact posture arithmetic unit 10c produces the polygon data of a conveyance feasible region 62. The data is used for determining whether the conveyance of the workpiece and set on the contact surface 61 (contact plane) of the lifter 60, for example. As illustrated in the example of FIG. 10B, the conveyance feasible region 62 has a width 63 the same as the width of the contact surface 61 of the lifter 60 and a length 65 the same as the length of the contact determining cuboid of the workpiece conveyed by the lifter 60 in a moving direction 64 of the lifter 60. The contact posture arithmetic unit 10c sets the produced conveyance feasible region 62 on the contact surface 61 of the lifter 60. The conveying motion arithmetic unit 10b performs the processing, for each time step, to set the conveyance feasible region for the respective conveying devices.

The contact posture arithmetic unit 10c calculates the gravity center positions of the contact determining cuboids of the respective workpieces. The contact posture arithmetic unit 10c determines, for each workpiece, whether the calculated gravity center position is included in the conveyance feasible region set to the conveying device that conveys the workpiece, the gravity center position of the contact determining cuboid of which is calculated. When the gravity center position of the contact determining cuboid of the workpiece is included in the conveyance feasible region set to a certain conveying device at the time step Tₖ, the contact posture arithmetic unit 10c performs the following processing. When determining that the gravity center position of the contact determining cuboid of the workpiece is included in the conveyance feasible region, the contact posture arithmetic unit 10c determines that the conveying device starts the conveyance of the workpiece. The contact posture arithmetic unit 10c determines that the pusher 30 starts conveying the workpiece 40 when determining that the gravity center of the contact determining cuboid of the workpiece is included in the conveyance feasible region at the time step Tₖ, as illustrated in the example of FIG. 2A, for example. The contact posture arithmetic unit 10c detects the point, the nearest point to the contact plane of the conveying device, of the contact determining cuboid. Subsequently, the contact posture arithmetic unit 10c determines the rotational direction of the contact determining cuboid when the contact determining cuboid of the workpiece is pushed in the moving direction of the conveying device. The contact posture arithmetic unit 10c then calculates the rotational amount of the contact determining cuboid when the contact plane, which is the surface pushing out or lifting up the workpiece and set to the conveying device, and the surface of the contact determining cuboid of the workpiece are in parallel with each other.

The contact posture arithmetic unit 10c starts rotating the contact determining cuboid of the workpiece by the calculated rotating amount in the determined direction when the conveying device moves to the position where the conveying device is in contact with the surface of the contact determining cuboid. The workpiece movement arithmetic unit 10d stops the rotation of the contact determining cuboid when the contact surface and the surface of the contact determining cuboid of the workpiece are in parallel with each other. The contact posture arithmetic unit 10c determines that the conveying device and the workpiece are in a contacting state in which the conveying device and the workpiece are in contact with each other. Subsequently, the contact posture arithmetic unit 10c notifies the workpiece movement arithmetic unit 10d of the conveying device and the workpiece being in the contacting state.

The contact posture arithmetic unit 10c detects the point 42, which is nearest to the contact surface 31 as illustrated in the example of FIG. 2A, for example. The contact posture arithmetic unit 10c then determines the direction 43, in which the contact determining cuboid is rotated about the gravity center of the contact determining cuboid of the workpiece 40 when the contact determining cuboid of the workpiece 40 is pushed in the moving direction of the pusher 30. The contact posture arithmetic unit 10c starts rotating the contact determining cuboid of the workpiece 40 by the calculated rotational amount in the determined direction 43 when the pusher 30 moves to the position where the pusher 30 is in contact with the surface 44 of the contact determining cuboid. The workpiece movement arithmetic unit 10d stops the rotation of the contact determining cuboid when the contact surface 31 and the surface 44 of the contact determining cuboid of the workpiece 40 are in parallel with each other. The contact posture arithmetic unit 10c determines that the pusher 30 and the workpiece 40 are in the contacting state in which the pusher 30 and the workpiece 40 are in contact with each other. Subsequently, the contact posture arithmetic unit 10c notifies the workpiece movement arithmetic unit 10d of the pusher 30 and the workpiece 40 being in the contacting state.

Referring back to FIG. 1, the workpiece movement arithmetic unit 10d calculates the movement of the workpiece in the conveyance. The workpiece movement arithmetic unit 10d performs the following processing when receiving, at the time step Tₖ, the conveying device and the workpiece in the contacting state from the contact posture arithmetic unit 10c, for example. The workpiece movement arithmetic unit 10d extracts the moving amount of the component of the movement vector of the conveying device in the contacting state at the time step Tₖ in the direction in which the posture of the conveying device changes. The workpiece movement arithmetic unit 10d then calculates the position of the workpiece when the workpiece is moved by the extracted moving amount in the direction in which the posture of the conveying device changes.

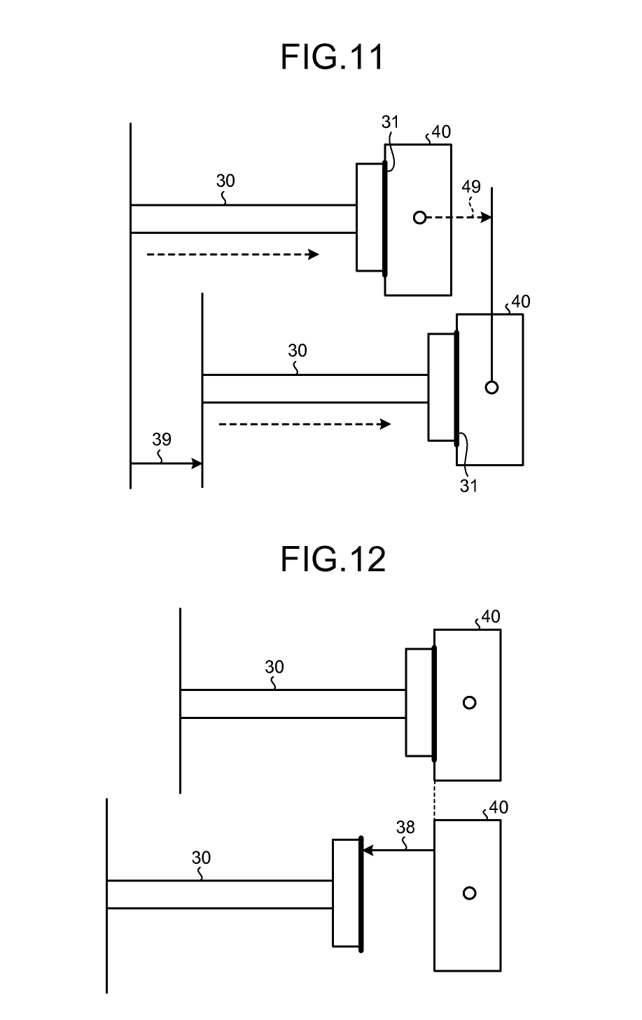

FIG. 11 is a schematic diagram for explaining an example of the processing performed by the workpiece movement arithmetic unit. The workpiece movement arithmetic unit 10d performs the following processing when receiving, at the time step Tₖ, that the pusher 30 and the workpiece 40 are in the contacting state as illustrated in the example of FIG. 11 from the contact posture arithmetic unit 10c. The workpiece movement arithmetic unit 10d extracts a moving amount 49 of the component of a movement vector 39 of the pusher 30 in the contacting state at the time step Tₖ in the direction in which the posture of the pusher 30 changes. The workpiece movement arithmetic unit 10d then moves the workpiece 40 by the extracted moving amount 49 in the direction in which the posture of the pusher 30 changes, and calculates the position of the workpiece 40. Thereafter, the workpiece movement arithmetic unit 10d calculates the position of the workpiece 40 while the pusher 30 and the workpiece 40 are in the contacting state when the pusher 30 moves in the direction in which the pusher 30 pushes out the workpiece 40.

In contrast, when the pusher 30 moves in the direction opposite the direction in which the pusher 30 pushes out the workpiece 40, the workpiece movement arithmetic unit 10d cancels the contacting state between the pusher 30 and the workpiece 40 at the time of the movement of the pusher 30 in the opposite direction. FIG. 12 is a schematic diagram for explaining another example of the processing performed by the workpiece movement arithmetic unit. The workpiece movement arithmetic unit 10d cancels the contacting state between the pusher 30 and the workpiece 40 when the moving direction indicated with a movement vector 38 of the pusher 30 is opposite the direction in which the pusher 30 pushes out the workpiece 40 as illustrated in FIG. 12. The workpiece movement arithmetic unit 10d then changes the posture of the pusher 30 in accordance with the movement vector 38.

The workpiece movement arithmetic unit 10d performs the following processing when receiving that the conveying device and the workpiece are in the contacting state, at the time step Tₖ, from the contact posture arithmetic unit 10c. The workpiece movement arithmetic unit 10d stores, in an internal memory, the coordinates of the workpiece in a height direction (the z-axis direction) when the workpiece is moved to a position where the workpiece is in contact with the contact surface, which serves as a supporting surface, of the lifter. The workpiece movement arithmetic unit 10d moves the workpiece to the position where the workpiece is in contact with the supporting surface of the lifter, and then extracts the moving amount of the movement vector of the lifter at the time step Tₖ in the direction in which the posture of the lifter changes when the lifter moves in a direction in which the lifter lifts up the workpiece. The workpiece movement arithmetic unit 10d then moves the workpiece by the extracted moving amount in the direction in which the posture of the lifter changes, and calculates the position of the workpiece. In contrast, when the lifter moves in the direction opposite the direction in which the lifter lifts up the workpiece, i.e., moves in the direction toward the ground, the workpiece movement arithmetic unit 10d cancels the contacting state between the lifter and the workpiece when the lifter reaches the height equal to the height stored in the internal memory.

The workpiece movement arithmetic unit 10d then notifies the three-dimensional posture arithmetic unit 11 of the positions and the posture angles of the respective conveying devices. The workpiece movement arithmetic unit 10d also notifies the three-dimensional posture arithmetic unit 16 of the gravity center positions and the posture angles of the contact determining cuboids of the respective workpieces.

Referring back to FIG. 1, the three-dimensional posture arithmetic unit 11 stores, in the conveying motion information table 5b, the positions and the posture angles of the respective conveying devices notified from the workpiece movement arithmetic unit 10d. The three-dimensional posture arithmetic unit 11 also stores, in the workpiece posture table 5d, the gravity center positions and the posture angles of the contact determining cuboids notified from the workpiece movement arithmetic unit 10d.

The three-dimensional posture arithmetic unit 11 reads out the shapes of the respective workpieces and the respective conveying devices that are stored in the three-dimensional data management unit 7. The three-dimensional posture arithmetic unit 11 then sets simulation spaces in which the read out shapes are arranged at the gravity center positions of the contact determining cuboids of the respective workpieces and the gravity center positions of the respective conveying devices. The three-dimensional posture arithmetic unit 11 sets the simulation spaces such that the respective workpieces and the respective conveying devices are at the corresponding posture angles. The three-dimensional posture arithmetic unit 11 then notifies the three-dimensional shape displaying control unit 12 of the information about the set simulation spaces.

The three-dimensional shape displaying control unit 12 produces, for each time step, images displayed by the output device 3 displaying the simulation spaces. When receiving the information about the simulation spaces from the three-dimensional posture arithmetic unit 11, the three-dimensional shape displaying control unit 12 produces the images of the received simulation spaces using a Z-buffer method or a scan-line method, and transmits the produced images to the output device 3.

The control software executing unit 8, the motor motion arithmetic unit 9, the simulation arithmetic unit 10, the three-dimensional posture arithmetic unit 11, and the three-dimensional shape displaying control unit 12 are electronic circuits, for example. Examples of the electronic circuits include integrated circuits such as an application specific integrated circuit (ASIC) and a field programmable gate array (FPGA), or a central processing unit (CPU), and a micro processing unit (MPU).

The management information storage unit 5, the motion parameter storage unit 6, and the three-dimensional data management unit 7 are semiconductor memory elements such as a random access memory (RAM) and a flash memory, and storage devices such as a hard disk drive and an optical disk drive.

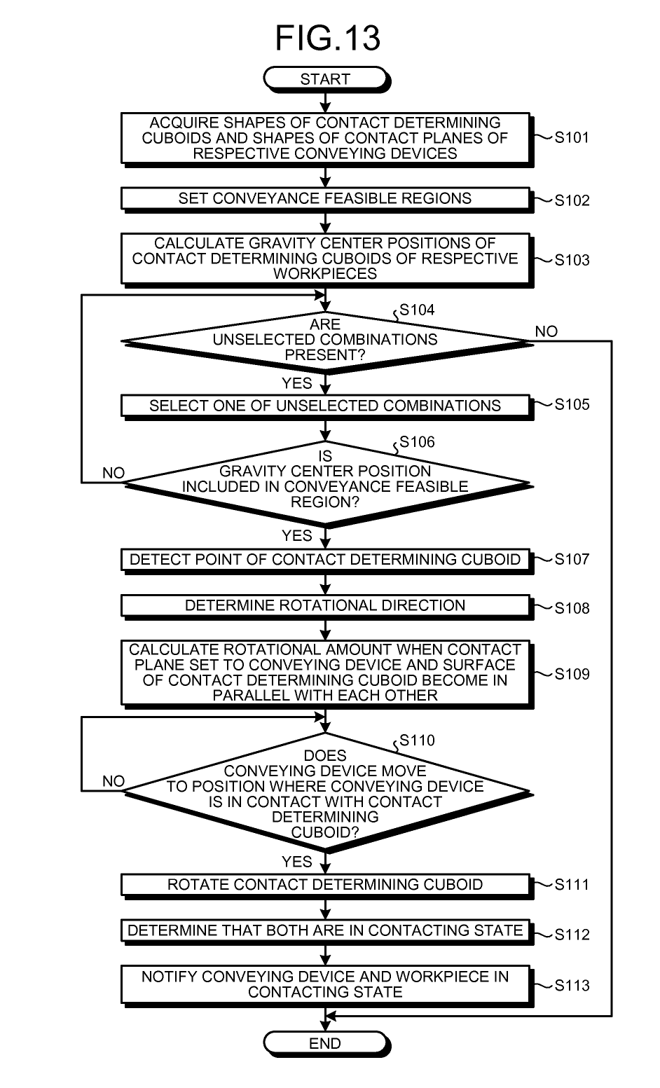

The following describes a flow of the processing performed by the arithmetic apparatus 1 with reference to FIGS. 13 to 17. FIG. 13 is a flowchart for explaining a flow of processing to determine the contact of the workpiece and the conveying device at a certain time step.

As illustrated in FIG. 13, the contact posture arithmetic unit 10c acquires the shapes of the contact determining cuboids and the shapes of the contact planes of the respective conveying devices from the contact determining cuboid table 6a and the contact plane table 6b (step S101). The contact posture arithmetic unit 10c then sets the conveyance feasible regions, which are used for determining whether the conveyance of the workpieces starts, on the contact planes of the respective conveying devices (step S102). Subsequently, the contact posture arithmetic unit 10c calculates the gravity center positions of the contact determining cuboids of the respective workpieces (step S103).

The contact posture arithmetic unit 10c determines whether unselected combinations are present in the combinations of the workpieces and the conveying devices conveying the corresponding workpieces (step S104). If no unselected combinations are present (No at step S104), the processing ends. If unselected combinations are present (Yes at step S104), the contact posture arithmetic unit 10c selects one of the unselected combinations (step S105). The contact posture arithmetic unit 10c then determines whether the gravity center position of the contact determining cuboid of the workpiece included in the selected combination is included in the conveyance feasible region set to the conveying device included in the selected combination (step S106).

If the contact posture arithmetic unit 10c determines that the gravity center of the contact determining cuboid of the workpiece is not included in the conveyance feasible region (No at step S106), the processing returns to step S104. If it is determined that the gravity center of the contact determining cuboid of the workpiece is included in the conveyance feasible region (Yes at step S106), the contact posture arithmetic unit 10c performs the following processing. The contact posture arithmetic unit 10c detects the point, the nearest point to the contact plane of the conveying device, of the contact determining cuboid (step S107). Subsequently, the contact posture arithmetic unit 10c determines the rotational direction of the contact determining cuboid when the contact determining cuboid of the workpiece is pushed in the moving direction of the conveying device (step S108). The contact posture arithmetic unit 10c then calculates the rotational amount of the contact determining cuboid when the contact plane, which is the surface pushing out or lifting up the workpiece and set to the conveying device, and the surface of the contact determining cuboid of the workpiece are in parallel with each other (step S109).

The contact posture arithmetic unit 10c then determines whether the conveying device has moved to the position where the conveying device is in contact with the surface of the contact determining cuboid (step S110). If the conveying device has not yet moved to the position where the conveying device is in contact with the surface of the contact determining cuboid (No at step S110), the contact posture arithmetic unit 10c performs the determination at step S110 again. If the conveying device has moved to the position where the conveying device is in contact with the surface of the contact determining cuboid (Yes at step S110), the contact posture arithmetic unit 10c rotates the contact determining cuboid of the workpiece by the calculated rotating amount in the determined direction (step S111). The contact posture arithmetic unit 10c then determines that the conveying device and the workpiece are in the contacting state in which the conveying device and the workpiece are in contact with each other (step S112). Subsequently, the contact posture arithmetic unit 10c notifies the workpiece movement arithmetic unit 10d of the conveying device and the workpiece in the contacting state (step S113), and then the processing ends.

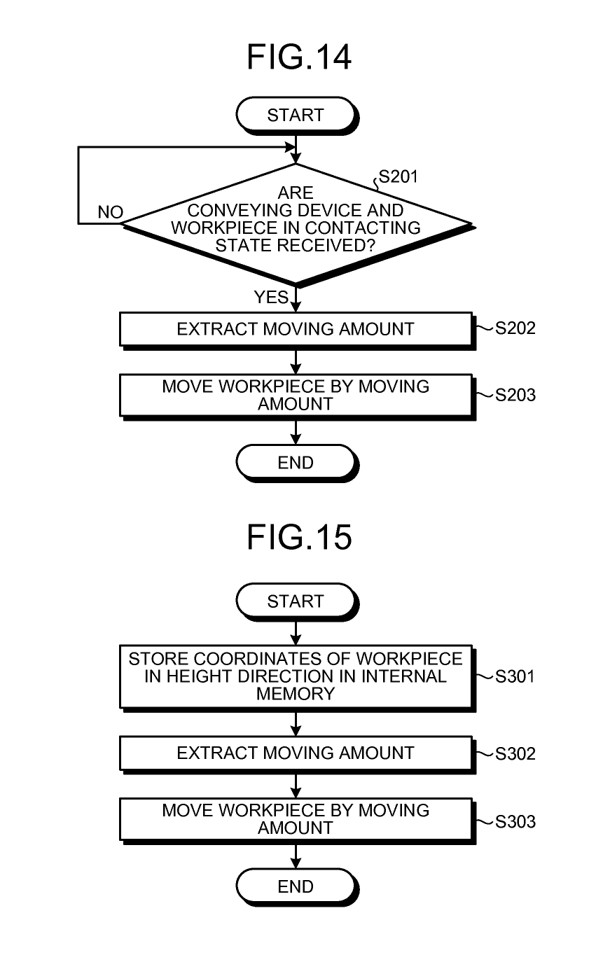

FIG. 14 is a flowchart for explaining a flow of processing to calculate the position of the workpiece at a certain time step. As illustrated in FIG. 14, the workpiece movement arithmetic unit 10d determines whether the conveying device and the workpiece in the contacting state are received from the contact posture arithmetic unit 10c (step S201). If the workpiece movement arithmetic unit 10d has not received them (No at step S201), the workpiece movement arithmetic unit 10d performs the determination at step S201 again. If the workpiece movement arithmetic unit 10d has received them (Yes at step S201), the workpiece movement arithmetic unit 10d performs the following processing. The workpiece movement arithmetic unit 10d extracts the moving amount of the component of the movement vector of the conveying device in the contacting state in the direction in which the posture of the conveying device changes (step S202). The workpiece movement arithmetic unit 10d then calculates the position of the workpiece when the workpiece is moved by the extracted moving amount in the direction in which the posture of the conveying device changes (step S203), and then the processing ends.

FIG. 15 is a flowchart for explaining a flow of processing to calculate the position of the workpiece when the workpiece and the lifter are in the contacting state at a certain time step. The processing illustrated in FIG. 15 is performed when the workpiece movement arithmetic unit 10d receives that the lifter and the workpiece are in the contacting state from the contact posture arithmetic unit 10c, for example. As illustrated in FIG. 15, the workpiece movement arithmetic unit 10d stores, in the internal memory, the coordinates of the workpiece in the height direction (the z-axis direction) when the workpiece is moved to the position where the workpiece is in contact with the contact surface, which serves as the supporting surface, of the lifter (step S301). The workpiece movement arithmetic unit 10d moves the workpiece to the position where the workpiece is in contact with the supporting surface of the lifter, and then extracts the moving amount of the movement vector of the lifter in the direction in which the posture of the lifter changes (step S302). The workpiece movement arithmetic unit 10d then moves the workpiece by the extracted moving amount in the direction in which the posture of the lifter changes and calculates the position of the workpiece (step S303), and then the processing ends.

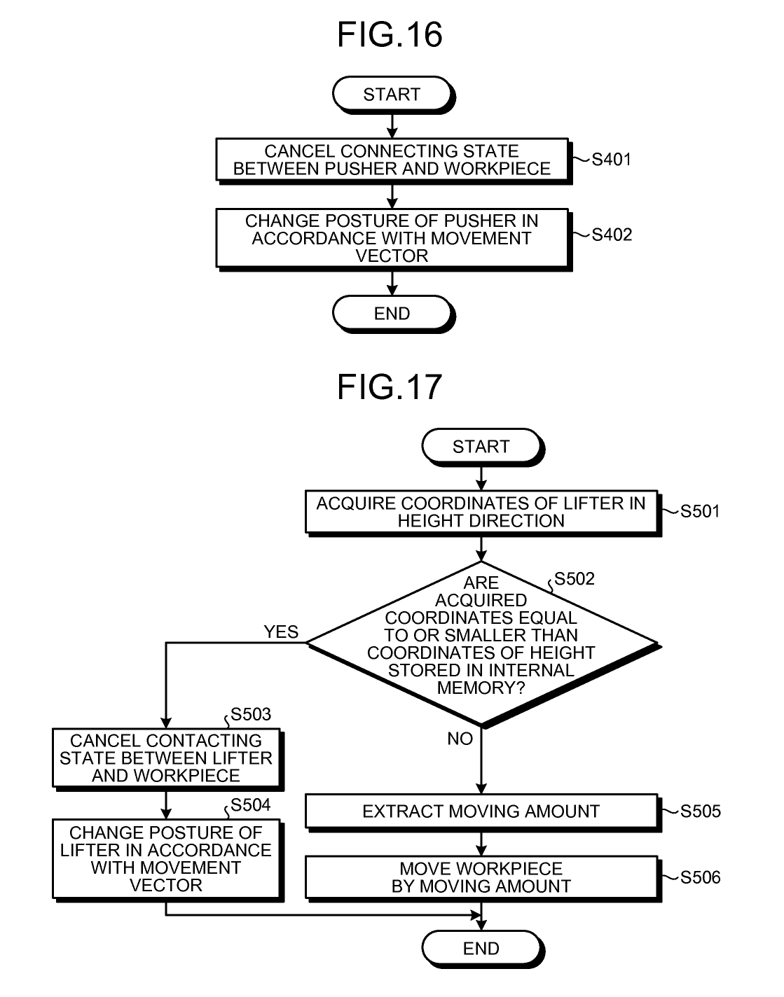

FIG. 16 is a flowchart for explaining processing to cancel the contacting state between the pusher and the workpiece at a certain time step. The processing illustrated in FIG. 16 is performed when the pusher and the workpiece are in the contacting state, and the moving direction indicated with the movement vector of the pusher is opposite the direction in which the pusher pushes out the workpiece, for example. The workpiece movement arithmetic unit 10d cancels the contacting state between the pusher and the workpiece (step S401). The workpiece movement arithmetic unit 10d then changes the posture of the pusher in accordance with the movement vector (step S402), and then the processing ends.

FIG. 17 is a flowchart for explaining processing to cancel the contacting state between the lifter and the workpiece at a certain time step. The processing illustrated in FIG. 17 is performed when the lifter and the workpiece are in the contacting state, and the moving direction indicated with the movement vector of the lifter is opposite the direction in which the lifter lifts up the workpiece, for example. As illustrated in FIG. 17, the workpiece movement arithmetic unit 10d acquires the coordinates of the lifter in the height direction from the coordinates transmitted from the conveying motion arithmetic unit 10b and indicating the position of the lifter (step S501). The workpiece movement arithmetic unit 10d determines whether the acquired coordinates of the height of the lifter are equal to or smaller than the coordinates of the height stored in the internal memory (step S502). If the acquired coordinates of the height of the lifter are equal to or smaller than the coordinates of the height stored in the internal memory (Yes at step S502), the workpiece movement arithmetic unit 10d cancels the contacting state between the lifter and the workpiece (step S503). The workpiece movement arithmetic unit 10d then changes the posture of the lifter in accordance with the movement vector (step S504), and then the processing ends.

If the acquired coordinates of the height of the lifter are not equal to or smaller than the coordinates of the height stored in the internal memory (No at step S502), the workpiece movement arithmetic unit 10d extracts the moving amount of the movement vector of the lifter in the direction in which the posture of the lifter changes (step S505). The workpiece movement arithmetic unit 10d then moves the workpiece by the extracted moving amount in the direction in which the posture of the lifter changes and calculates the position of the workpiece (step S506), and then the processing ends.

As described above, the arithmetic apparatus 1 performs the following processing. The arithmetic apparatus 1 performs the arithmetic operation to simulate the conveyance of the workpiece 40 by the pusher 30 in the three-dimensional simulation space in which the workpiece 40 and the pusher 30 moving the workpiece 40 by pushing the workpiece 40 with the contact surface 31 (i.e., pushing-out surface) of the pusher 30 are arranged. The arithmetic apparatus 1 also performs the arithmetic operation to simulate the conveyance of the workpiece 70 by the lifter 60 in the three-dimensional simulation space in which the workpiece 70 and the lifter 60 lifting up the workpiece 70 by supporting the workpiece 70 with the contact surface 61 (i.e., supporting surface) of the lifter 60 are arranged. The arithmetic apparatus 1 performs the following processing when detecting that the gravity center of the workpiece 40 is present in the conveyance feasible region set to the contact surface 31 of the pusher 30 in the arithmetic operation to simulate the conveyance. The arithmetic apparatus 1 moves the workpiece 40 to the position where the workpiece 40 is in contact with the contact surface 31 of the pusher 30. The arithmetic apparatus 1 performs the following processing when detecting that the gravity center of the workpiece 70 is present in the conveyance feasible region set to the contact surface 61 of the lifter 60 in the arithmetic operation to simulate the conveyance. The arithmetic apparatus 1 moves the workpiece 70 to the position where the workpiece 70 is in contact with the contact surface 61 of the lifter 60.

This makes it possible for the arithmetic apparatus 1 to simulate the conveying conditions of the workpieces 40 and 70 in the same state in which the pusher and the lifter actually convey the workpieces without the state where the pusher 30 and the lifter 60 are embedded in the workpiece 40 and the workpiece 70, respectively. The arithmetic apparatus 1 thus can suppress a deterioration in positional accuracy of the workpiece calculated in the simulation. Consequently, the arithmetic apparatus 1 enables the control program to be verified with high accuracy.

In the arithmetic apparatus 1, the posture of the workpiece 40 when conveyed by the pusher 30 is the same as that when actually conveyed by the pusher. In the arithmetic apparatus 1, the posture of the workpiece 70 when conveyed by the lifter 60 is the same as that when actually conveyed by the lifter. This makes it possible for the arithmetic apparatus 1 to simulate the conveying conditions of the workpieces 40 and 70 in the same states as the case in which the pusher and the lifter actually convey the workpieces. The arithmetic apparatus 1 thus can suppress a deterioration in positional accuracy of the workpiece calculated in the simulation. Consequently, the arithmetic apparatus 1 enables the control program to be verified with high accuracy.

When the workpiece and the conveying device conveying the workpiece are in contact with each other, the arithmetic apparatus 1 extracts the moving amount of the component in a direction in which the posture of the conveying device changes out of the components in the moving direction of the conveying device, and moves the workpiece by the extracted moving amount. This makes it possible to individually simulate the workpiece and the conveying device. When the conveying device conveys the workpiece while sliding on a surface of the workpiece, and the workpiece and the conveying device in the contacting state are integrated, the conveying device cannot slide on the surface of the workpiece. Thus, the simulation performed on the basis of the assumption that the workpiece and the conveying device in the contacting state are integrated does not simulate the conveying condition of the workpiece with high accuracy in some cases. In contrast, the arithmetic apparatus 1 extracts the moving amount of the component in the direction in which the posture of the conveying device changes out of the components in the moving direction of the conveying device, and causes the workpiece to move by the extracted moving amount. Consequently, the arithmetic apparatus 1 can perform the simulation with high accuracy even when the conveying device conveys the workpiece while sliding on a surface of the working piece.

When the pusher moves in the direction in which the pusher pushes out the workpiece after the workpiece is moved to the position where the workpiece is in contact with the pushing-out surface of the pusher, the arithmetic apparatus 1 continues the arithmetic operation to simulate the conveyance while the pusher and the workpiece are in the contacting state. When the pusher moves in the direction opposite the direction in which the pusher pushes out the workpiece, the arithmetic apparatus 1 cancels the contacting state between the pusher and the workpiece at the time of the movement of the pusher in the opposite direction, and determines that the pusher and the workpiece are separated objects.

The arithmetic apparatus 1 stores, in the storage unit, the information about the height coordinates of the workpiece when the workpiece is moved to the position where the workpiece is in contact with the supporting surface of the lifter. When the lifter moves in the direction in which the lifter lifts up the workpiece after the workpiece is moved to the position where the workpiece is in contact with the supporting surface of the lifter, the arithmetic apparatus 1 continues the arithmetic operation to simulate the conveyance while the lifter and the workpiece are in the contacting state. When the lifter moves in the direction opposite the direction in which the lifter lifts up the workpiece, the arithmetic apparatus 1 cancels the contacting state between the lifter and the workpiece when the lifter reaches the height equal to the height stored in the storage unit, and determines that the lifter and the workpiece are separated objects.

The arithmetic apparatus 1 determines the rotational center and the rotational direction of the workpiece using the contact determining cuboid surrounding the workpiece in a circumscribing manner. This makes it possible for the arithmetic apparatus 1 to rotate the workpiece without increasing the amount of calculation.

The embodiment of the present invention is described above. The present invention, however, may be implemented in various forms other than the embodiment described above. The following describes other embodiments.

Contact Determining Cuboid

The arithmetic apparatus 1 uses the cuboid surrounding the workpiece in a circumscribing manner as the contact determining cuboid. The embodiment, however, is not limited to this manner. The arithmetic apparatus 1 can receive the polygon data of the contact determining cuboid set by a user in any manner from the input device 2 and store the received polygon data in the contact determining cuboid table 6a.

Workpiece and Conveying Device

The workpieces and the various types of conveying devices illustrated in the embodiment are by way of example only. The arithmetic apparatus 1 can perform the simulation using the workpieces having any shape and the conveying devices having any shape. The various conveying devices described above are by way of example. The arithmetic apparatus 1 can perform the simulation using the conveying devices having any function.

Computer Program

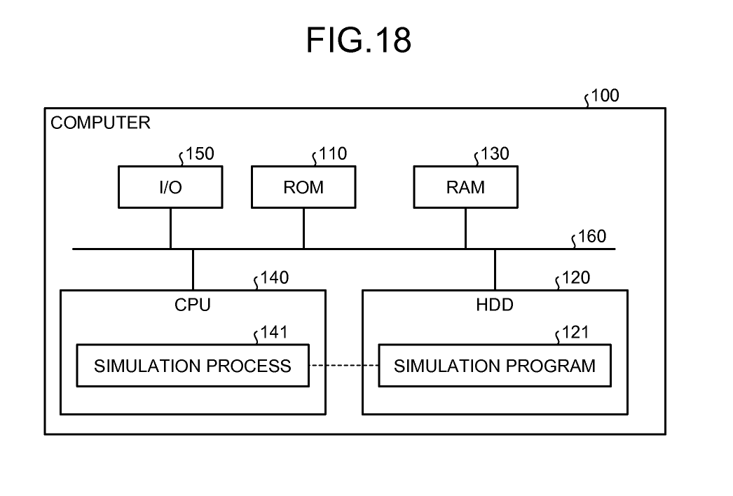

The arithmetic apparatus 1 in the embodiment executes the various types of processing using hardware. The embodiment, however, is not limited to this manner. The various types of processing may be achieved by a computer included in the arithmetic apparatus 1 executing a preliminarily prepared computer program. The following describes an example of a computer that executes a computer program having the same functions as the arithmetic apparatus 1 in the embodiment with reference to FIG. 18. FIG. 18 is a schematic diagram for explaining an example of the computer executing a simulation program.

In a computer 100 exemplarily illustrated in FIG. 18, a read only memory (ROM) 110, a hard disk drive (HDD) 120, a random access memory (RAM) 130, and a central processing unit (CPU) 140 are coupled with each other through a bus 160. The computer 100 exemplarily illustrated in FIG. 18 also includes an input-output (I/O) 150 used for transmitting and receiving data.

The HDD 120 preliminarily stores therein a simulation program 121. In the example illustrated in FIG. 18, the CPU 140 reads out the simulation program 121 from the HDD 120 and executes the simulation program 121, thereby causing the simulation program 121 to function as a simulation process 141. The simulation process 141 demonstrates the same functions as the control software executing unit 8, the motor motion arithmetic unit 9, the simulation arithmetic unit 10, the three-dimensional posture arithmetic unit 11, and the three-dimensional shape displaying control unit 12, which are illustrated in FIG. 1.

The simulation program 121 described in the embodiment can be distributed through a network such as the Internet. This program is recorded in a recording medium readable by a computer, such as a hard disc, a flexible disc (FD), a compact disc read only memory (CD-ROM), a magneto optical disc, or a digital versatile disc (DVD). This program can be also executed by a computer after the computer reads out the program from the recording medium.

An arithmetic apparatus and arithmetic method according to an aspect of an embodiment of the invention can suppress a deterioration in accuracy of the simulation.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium having stored therein a computer program that causes a computer to execute a process comprising:
performing arithmetic operation to simulate conveyance of an object by a conveying device in a three-dimensional simulation space in which the object and the conveying device are disposed, the conveying device moving the object by pushing the object with a pushing-out surface of a pusher or lifting up the object by supporting the object from below with a supporting surface of a lifter; and
moving the object to a position where the object is in contact with the pushing-out surface of the pusher or the supporting surface of the lifter when it is detected that a certain reference point of the object is present in a certain region in a moving direction of the pushing-out surface of the pusher or the supporting surface of the lifter at the performing the arithmetic operation to simulate the conveyance.

2. The computer-readable recording medium according to claim 1, wherein at the performing the arithmetic operation to simulate the conveyance, the arithmetic operation to simulate the conveyance continues while the pusher and the object are integrated when the pusher moves in a direction in which the pusher pushes out the object after the object is moved to the position where the object is in contact with the pushing-out surface of the pusher, and
when the pusher moves to a direction opposite the direction in which the pusher pushes out the object, the pusher and the object are determined as being separated at time of the movement of the pusher in the opposite direction.

3. The computer-readable recording medium according to claim 1, wherein at the performing the arithmetic operation to simulate the conveyance,
information about height coordinates of the object at the position when the object is moved to the position where the object is in contact with the supporting surface of the lifter is stored in a storage unit,
the arithmetic operation to simulate the conveyance continues while the lifter and the object are integrated when the lifter moves in a direction in which the lifter lifts up the object after the object is moved to the position where the object is in contact with the supporting surface of the lifter, and
when the lifter moves in a direction opposite the direction in which the lifter lifts up the object, the lifter and the object are determined as being separated when the lifter reaches a height equal to the height stored in the storage unit.

4. An arithmetic apparatus, comprising:
an executing unit that performs arithmetic operation to simulate conveyance of an object by a conveying device in a three-dimensional simulation space in which the object and the conveying device are disposed, the conveying device moving the object by pushing the object with a pushing-out surface of a pusher or lifting up the object by supporting the object from below with a supporting surface of a lifter; and
a movement controller that moves the object to a position where the object is in contact with the pushing-out surface of the pusher or the supporting surface of the lifter when it is detected that a certain reference point of the object is present in a certain region in a moving direction of the pushing-out surface of the pusher or the supporting surface of the lifter in the arithmetic operation to simulate the conveyance.

5. An arithmetic method executed by a computer, the arithmetic method comprising:
performing arithmetic operation to simulate conveyance of an object by a conveying device in a three-dimensional simulation space in which the object and the conveying device are disposed, the conveying device moving the object by pushing the object with a pushing-out surface of a pusher or lifting up the object by supporting the object from below with a supporting surface of a lifter; and
moving the object to a position where the object is in contact with the pushing-out surface of the pusher or the supporting surface of the lifter when it is detected that a certain reference point of the object is present in a certain region in a moving direction of the pushing-out surface of the pusher or the supporting surface of the lifter in the arithmetic operation to simulate the conveyance.
